(19) United States
(12) Patent Application Publication
(10) Pub. No.: US 2026/0252768 A1
(43) Pub. Date: Aug. 27, 2026

(54) FOUR-DIMENSIONAL ASSIMILATION METHOD FOR WIND FARM DATA BASED ON PHYSICAL CONSTRAINTS AND GENERATIVE AI

(71) Applicant: Beijing Goldwind Smart Energy Technology Co., Ltd, Beijing (CN)

(72) Inventors: Hui MA, Beijing (CN); Yunzhi ZHOU, Beijing (CN); Shuanglong JIN, Beijing (CN)

(21) Appl. No.: 19/651,881

(22) Filed: Apr. 20, 2026

Related U.S. Application Data
(63) Continuation of application No. PCT/CN2026/087431, filed on Mar. 31, 2026.

(51) Int. Cl. G06F 30/27; G06F 111/04

(52) U.S. Cl. CPC G06F 30/27; G06F 2111/04

(57) ABSTRACT

The present disclosure discloses a four-dimensional assimilation method for wind farm data based on physical constraints and generative AI, belonging to the technical field of numerical weather prediction and wind energy prediction. The method includes: collecting various types of wind-detecting observation data from a wind farm and performing quality control; performing multi-scale preprocessing and uncertainty encoding on raw data of background field; encoding the wind-detecting observation data into conditional features; using the raw data of background field and the conditional features as joint conditional inputs to drive a generative model, and performing a reverse denoising sampling to generate a preliminary 3D analysis field; applying soft constraints and a projection correction based on physical constraints such as MO similarity theory and wake model; and performing multi-sample generation and statistical integration to output a mean and a uncertainty of analysis field and products for key height layers of wind power.

### TECHNICAL FIELD

The present disclosure belongs to the technical solution of numerical weather prediction and wind energy prediction, and particularly relates to a four-dimensional assimilation method for wind farm data based on physical constraints and generative AI.

### BACKGROUND

Wind power generation is highly sensitive to the fine structure of the wind farm within the boundary layer at a height of 10-200 meters near the ground. The initial fields of existing numerical weather prediction (NWP) models or artificial intelligence (AI) prediction large models usually originate from reanalysis data with low horizontal resolution (greater than 3 kilometers) or traditional data assimilation (DA) systems, which lack sufficient characterization of the near-surface-layer wind field in an area where the wind farm is located, making it difficult to accurately reflect key effects such as complex terrain, thermal stability, and wind turbine wake, directly affecting the accuracy of wind power prediction.

The wind-detecting data of the wind farm itself, such as wind speed inverted from power data of wind-detecting towers, cabin anemometers, Light Detection And Ranging (LIDAR), Sonic Detection And Ranging (SODAR), and Supervisory Control And Data Acquisition (SCADA) system, has characteristics of sparsity, irregularity, asynchrony, and multiple types. These valuable local observations are difficult to directly integrate into the grid data assimilation framework through traditional grid interpolation methods. However, traditional variational (three-dimensional (3D)/four-dimensional (4D)-Var) or ensemble (EnVar) assimilation methods face difficulties when applied to wind fields at near surface layer. Firstly, processing observations such as radial velocity from scanning LIDAR requires complex and nonlinear observation operators, and linear approximation can introduce significant errors. Secondly, they are very difficult to balance boundary layer physics (such as Monin-Obukhov theory) and terrain effects in the cost function. Thirdly, the cost of constructing and maintaining adjoint patterns is extremely high.

In recent years, the ideas of generative AI and Physical Information Neural Networks (PINNs) have provided new ideas for achieving end-to-end assimilation from irregular observations to physically consistent grid fields. However, there is currently a lack of specialized systems for applications at wind power near surface layer that can be industrially deployed. Therefore, there is an urgent used for a generative assimilation system that does not require adjoint patterns, can natively integrate local wind-detecting data from wind farms, and is embedded with physical constraints from boundary layer to significantly improve the analysis quality of wind fields at near surface layer and the prediction capabilities of wind power.

### SUMMARY

The purpose of the present disclosure is to provide a four-dimensional assimilation method for wind farm data based on physical constraints and generative AI, which solves the problems of insufficient characterization of the near-surface-layer wind field of wind power by numerical models in the existing technology, difficulty in integrating local observations of wind farms with traditional assimilation methods, and high computational costs.

To achieve the above objectives, the present disclosure provides a four-dimensional assimilation method for wind farm data based on physical constraints and generative AI, including:
S1: collecting sparse, irregular, and asynchronous wind-detecting observation data from a wind farm and performing quality control to obtain wind-detecting observation data at multiple moments within an assimilation time window;
S2: obtaining a raw data of a short-term and impending prediction from a previous moment as a raw data of a background field, and performing multi-scale preprocessing and uncertainty encoding on the raw data of the background field;
S3: encoding the wind-detecting observation data at the multiple moments in S1 into conditional features including spatial position, height, time, type, and quality identification through a multi-source observation encoder;
S4: using the raw data of the background field after the multi-scale preprocessing and the uncertainty encoding in S2 and the conditional features in S3 as joint conditional inputs to drive a generative model, and performing a reverse denoising sampling to generate a preliminary three-dimensional (3D) analysis field;
S5: during and/or after a generation of the preliminary 3D analysis field, applying soft constraints and a projection correction to the preliminary 3D analysis field generated in S4 based on the physical constraints composed of boundary layers and large-scale physical equations to obtain a physically compliant 3D analysis field; and
S6: performing multi-sample generation and statistical integration on the physically compliant 3D analysis field in S5 to output a mean and a uncertainty of the physically compliant 3D analysis field, and providing products and quality indicators for key height layers of wind power.

In some embodiments, the wind-detecting observation data in S1 includes: tower anemometer data, cabin anemometer data, sonic detection and ranging (SODAR)/light detection and ranging (LIDAR) profile data and scanning data, supervisory control and data acquisition (SCADA) power data and wind speed data derived thereof, and/or traditional meteorological observation data.

In some embodiments, S4 specifically includes:
S401: constructing the joint conditional inputs;
S402: constructing an overall objective function of the generative model;
S403: constructing a loss function of the physical constraints; and
S404: driving the generative model for performing the reverse denoising sampling to generate the preliminary 3D analysis field.

In some embodiments, an expression of the overall objective function of the generative model constructed in S402 is as follows:

Lₜₒₜₐₗ=L_{diff}+λ_{phy}L_{phy}+λ_{obs}L_{obs}+λ_{bak}L_{bak};
where Lₜₒₜₐₗ is a total training loss of the generative model; L_{diff} is a fundamental loss of a diffusion model; λ_{phy} is a weight coefficient of a physical loss; L_{phy} is a loss term of the physical constraints, which is a set term that includes a sum of a molecular orbital (MO) theoretical residual, a quality continuity residual, and multiple physical sub terms; Nobs is a weight coefficient of an observation loss; L_{obs} is a loss term of an observation fitting; λ_{bak} is a weight coefficient of a background field constraint, and L_{bak} is a loss term of the background field constraint.

In some embodiments, an expression of the loss function of the physical constraints constructed in S403 is as follows:

$${L}_{MO} = {‖ \frac{κ z}{u *} \frac{\partial U}{\partial z} - {ϕ}_{m} ( \frac{z}{L} ) ‖}^{2} ;$$

where L_{MO} is an Monin-Obukhov physical residual loss; κ is a von Karman constant; z is a vertical height; u* is a friction velocity; U is an average wind speed;

$$\frac{\partial U}{\partial z}$$

is a wind shear; φₘ is a momentum dimensionless wind shear function; L is an Monin-Obukhov length; ∥⋅|² is an L2 norm, and

$$\frac{z}{L}$$

is an atmospheric stability parameter.

In some embodiments, S5 specifically includes:
S501: calculating a physical residual of the preliminary 3D analysis field;
S502: incorporating the physical residual as a penalty term into the loss function of the physical constraints L_{MO} as the soft constraints; and
S503: performing the projection correction on the preliminary 3D analysis field.

In some embodiments, the calculating the physical residual of the preliminary 3D analysis field in S501 includes:
calculating continuity Navier-Stokes equations in fluid mechanics and thermodynamic equations of the preliminary 3D analysis field; and calculating the physical residual under an Monin-Obukhov similarity function using differentiable observation operators;
using the differentiable observation operators to map a generated 3D grid point wind field x back to an observation space to obtain a simulated observation value y_{pred}, where y_{pred} is expressed as:

$${y}_{pred} = H ( x ) ;$$

where H(⋅) represents a differentiable observation operator;
calculating an observation residual based on y_{pred}, expressed as:

∥y−H(x)∥;
where y represents an actual observation value, and ∥⋅∥ represents a norm; and
updating a wind field based on the observation residual;
where the differentiable observation operators include at least one of a geometry operator for radial velocity of a scanning LIDAR, an interpolation operator for a tower/cabin height and terrain consistency, a correction operator for a cabin wind speed yaw/pitch, a differentiable mapping operator for an SCADA power-wind speed-air density, a transfer operator for a satellite radiation, a refractive index operator for a Global Navigation Satellite System (GNSS) occultation, and an interpolation for a ground observation.

In some embodiments, the soft constraints in S502 include: soft constraints for an Monin-Obukhov similarity theory and soft constraints for a wake;
where the soft constraints for the Monin-Obukhov similarity theory include: joint residual penalties for a wind speed profile function, a stability function, and a consistency of a surface flux closure; and
the soft constraints for the wake are constructed based on a parameterized wake model, and impose a lightweight penalty of amplitude and range on a low-frequency wind speed loss in a downwind direction of a unit.

In some embodiments, the performing the projection correction on the preliminary 3D analysis field in S503 includes:
using a manifold projection technology to forcibly correct the preliminary 3D analysis field to a feasible domain that satisfies the physical constraints, achieving the projection correction.

In some embodiments, S6 specifically includes:
using randomness of the generative model to perform multiple parallel samples on an input at a same moment and under same conditions, calculating a statistical mean of all sampled samples as a final analysis value of a wind field, and calculating a pixel level variance as an uncertainty measure of a wind speed at the same moment.

Therefore, the present disclosure adopts the above-mentioned four-dimensional assimilation method for wind farm data based on physical constraints and generative AI, which has the following beneficial effects.
(1) A unified encoding framework and differentiable forward operators have been constructed, which can natively support direct assimilation of various specific observations of wind farms such as tower/nacelle, SODAR/LIDAR profile and scanning, SCADA power derived wind speed, etc.
(2) By using Monin-Obukhov similarity theory and key boundary layer physics such as surface flux closure as soft constraints, the non physical shear and energy anomalies of the analysis field at heights of 10-200 meters are significantly reduced.
(3) No adjoint patterns are required, and the reasoning steps are few. It can support the deployment of edge computing nodes at the wind farm level, and also supports hybrid deployment in the central cloud, realizing efficient rolling updates.
(4) By generating and outputting pixel-level variance through multiple samples, key basis is provided for confidence interval evaluation of wind power prediction and risk management and control of the power grid.
(5) The ability to integrate traditional data such as satellites, radio occultations, and ground observations, while balancing the accuracy of large-scale background fields with local wind power characteristics, has improved the analysis quality of wind field in complex terrains and nearshore areas.

The technical solution of the present disclosure will be further described in detail through the accompanying drawings and embodiments.

### BRIEF DESCRIPTION OF THE DRAWINGS

FIG. 1 is a flowchart of the complete implementation process according to embodiments of the present disclosure.

FIG. 2 is a schematic diagram of the training process according to embodiments of the present disclosure.

FIG. 3 is a schematic diagram of differentiable observation operators specialized for wind power according to embodiments of the present disclosure.

FIG. 4 is a schematic diagram of the physical constraints of boundary layer according to embodiments of the present disclosure.

FIG. 5 is a schematic diagram of a four-dimensional assimilation window according to embodiments of the present disclosure.

FIG. 6 is a flowchart of the overall system architecture according to embodiments of the present disclosure.

### DETAILED DESCRIPTION

In order to make the purpose, technical solution, and advantages of the disclosed embodiments of the present disclosure clearer and more understandable, the present disclosure will be further described in detail below in conjunction with the accompanying drawings and embodiments. It should be understood that the specific embodiments described here are only used to explain the embodiments of the present disclosure and are not intended to limit the embodiments of the present disclosure. Based on the embodiments of the present disclosure, all other embodiments obtained by ordinary skilled in the art without creative labor are within the scope of protection of the present disclosure. The embodiments are shown in the accompanying drawings, where identical or similar reference numerals from beginning to end represent identical or similar elements or elements with identical or similar functions.

It should be noted that the terms “including” and “having”, as well as any variations thereof, are intended to cover non exclusive inclusions, such as processes, methods, systems, products, or servers that contain a series of steps or units, and are not necessarily limited to those steps or units clearly listed, but may include other steps or units that are not clearly listed or inherent to these processes, methods, products, or devices.

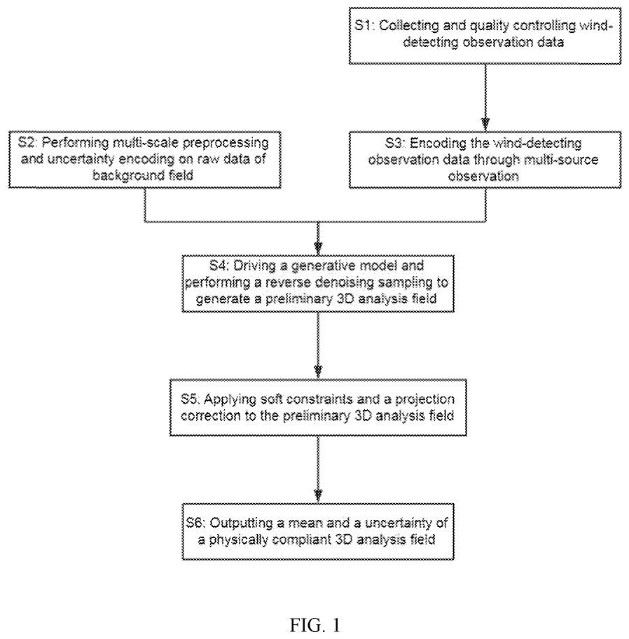

Below, a detailed explanation of the embodiments of the present disclosure will be provided in conjunction with FIGS. 1-6.

A four-dimensional assimilation method for wind farm data based on physical constraints and generative AI includes following S1 to S6.

In S1, sparse, irregular, and asynchronous wind-detecting observation data is collected from a wind farm and quality control is performed to obtain wind-detecting observation data at multiple moments within an assimilation time window.

The wind-detecting observation data specifically includes: tower anemometer data, cabin anemometer data, sonic detection and ranging (SODAR)/light detection and ranging (LIDAR) profile data and scanning data, supervisory control and data acquisition (SCADA) power data and wind speed data derived thereof, and/or traditional meteorological observation data.

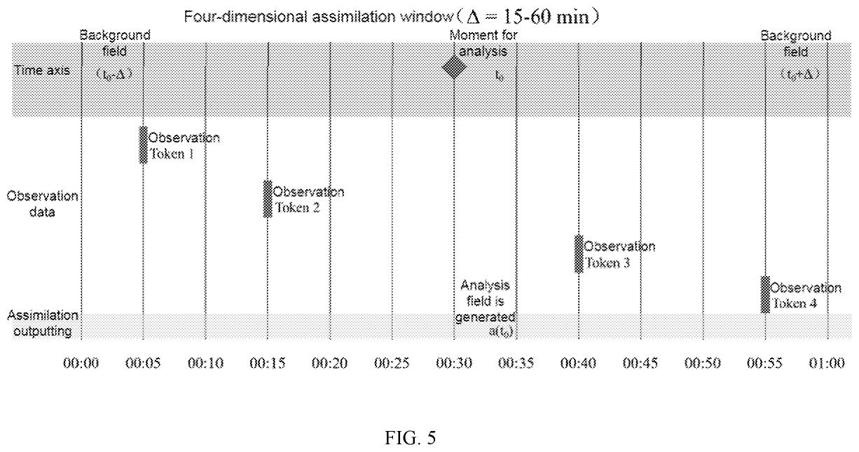

The assimilation time window is 15-60 minutes (min), and four-dimensional consistency of weak constraints is achieved by using background slices on both sides and time discrete residuals, as shown in FIG. 5.

In S2, a raw data of a short-term and impending prediction is obtained from a previous moment as a raw data of a background field, and multi-scale preprocessing and uncertainty encoding are performed on the raw data of the background field.

In S3, the wind-detecting observation data at the multiple moments collected in S1 is encoded into conditional features including spatial position, height, time, type, and quality identification through a multi-source observation encoder.

In S4, the raw data of the background field after the multi-scale preprocessing and the uncertainty encoding obtained in S2 and the conditional features output in S3 are used as joint conditional inputs to drive a generative model, and a reverse denoising sampling is performed to generate a preliminary three-dimensional (3D) analysis field.

S4 specifically includes following S401 to S404.

In S401, the joint conditional inputs are constructed.

In S402, an overall objective function of the generative model is constructed.

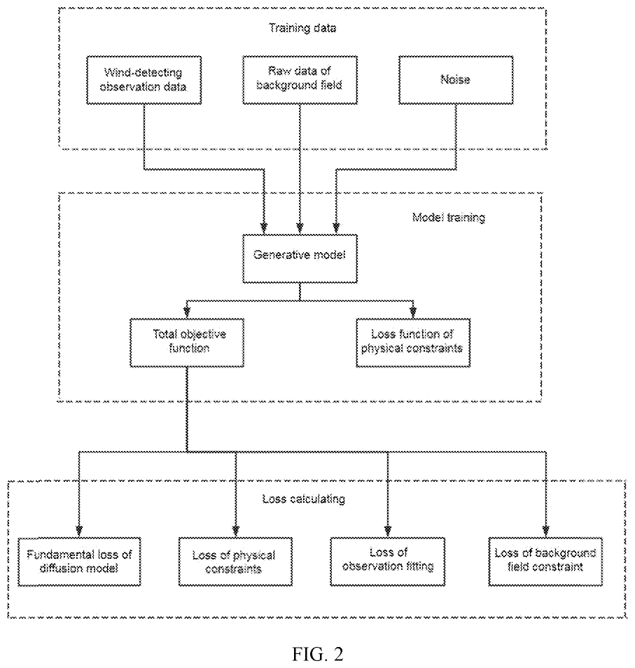

The loss function during training of the generative model includes: a fitting term for observation, a constraint term for background field, and a constraint term for physical rule. The training process is shown in FIG. 2.

An expression of the overall objective function of the generative model is constructed as follows:

$${L}_{total} = {L}_{diff} + {λ}_{phy} {L}_{phy} + {λ}_{obs} {L}_{obs} + {λ}_{b a k} {L}_{b a k} .$$

Lₜₒₜₐₗ is a total training loss of the generative model. L_{diff} is a fundamental loss of a diffusion model. λ_{phy} is a weight coefficient of a physical loss, and is a hyperparameter. L_{phy} is a loss term of the physical constraints, which is a set term that includes a sum of a molecular orbital (MO) theoretical residual, a quality continuity residual, a surface flux closure residual, a geostrophic balance residual, and an optional wake model residual. λ_{obs} is a weight coefficient of an observation loss, used to adjust the constraint strength of observation data on the generated results. L_{obs} is a loss term of an observation fitting, which represents the difference between the generated field mapped by the observation operators and the real observation data. λ_{bak} is a constraint weight coefficient of a background field constraint. L_{bak} is a loss term of the background field constraint.

In S403, a loss function of the physical constraints is constructed.

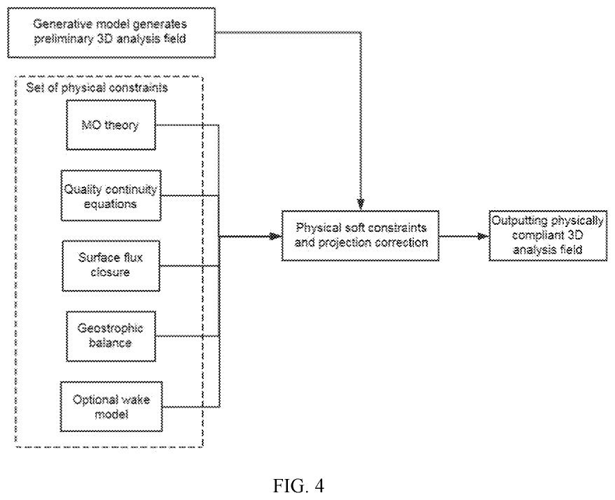

As shown in FIG. 4, an expression of the loss function of the physical constraints L_{MO} is constructed as follows:

$${L}_{MO} = {‖ \frac{κ z}{u *} \frac{\partial U}{\partial z} - {ϕ}_{m} ( \frac{z}{L} ) ‖}^{2} .$$

L_{MO} is an Monin-Obukhov physical residual loss, representing the degree of deviation between the generated wind field and classical near-surface-layer meteorological physics theory. κ is a von Karman constant, which is a dimensionless meteorological constant typically taken as 0.40 or 0.41. z is a vertical height, which refers to the vertical distance from the ground, and in the present disclosure, it specifically refers to the height range of the near surface layer that the wind farm is concerned with. u* is a friction velocity, which describes the characteristic velocity scale of turbulence intensity in the near surface layer. U is an average wind speed, which refers to the horizontal wind speed component at the height z.

$$\frac{\partial U}{\partial z}$$

is a wind shear, which is the vertical gradient of wind speed and represents the rate at which wind speed changes with height. φₘ is a momentum dimensionless wind shear function, which is a universal function in Monin-Obukhov similarity theory and describes the influence of atmospheric stability on wind speed profiles. L is an Monin-Obukhov length, which is a parameter with a length dimension that characterizes the dynamic properties of atmospheric turbulence in the near surface layer, and a positive value represents a stable stratification, while a negative value represents a unstable stratification. ∥⋅∥² is an L2 norm.

$$\frac{z}{L}$$

is a parameter for atmospheric stability, which is a dimensionless parameter, and used to determine the stable state of atmosphere.

In S404, the generative model is driven for performing the reverse denoising sampling to generate the preliminary 3D analysis field.

In S5, during and/or after a generation of the preliminary 3D analysis field, soft constraints and a projection correction are applied to the preliminary 3D analysis field generated in S4 based on physical constraints composed of boundary layers and large-scale physical equations to obtain a physically compliant 3D analysis field.

S5 specifically includes following S501 to S503.

In S501, a physical residual of the preliminary 3D analysis field is calculated.

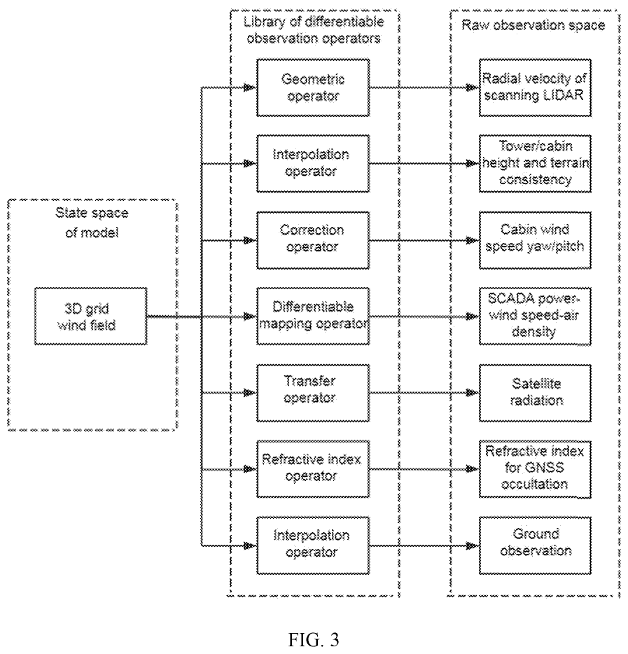

Specifically, continuity Navier-Stokes equations in fluid mechanics and thermodynamic equations of the preliminary 3D analysis field are calculated. The physical residual under an Monin-Obukhov similarity function is calculated using differentiable observation operators. The differentiable observation operators are shown in FIG. 3.

The differentiable observation operators are used to map a generated 3D grid point wind field x back to an observation space to obtain a simulated observation value y_{pred}. y_{pred} is expressed as:

$${y}_{pred} = H ( x ) ;$$

where H(⋅) represents a differentiable observation operator.

An observation residual is calculated based on y_{pred}, expressed as:

∥y−H(x)∥;
where y represents an actual observation value, and ∥⋅∥ represents a norm.

A wind field is updated based on the observation residual.

The differentiable observation operators include at least one of a geometry operator for radial velocity of a scanning LIDAR, an interpolation operator for a tower/cabin height and terrain consistency, a correction operator for a cabin wind speed yaw/pitch, a differentiable mapping operator for an SCADA power-wind speed-air density, a transfer operator for a satellite radiation, a refractive index operator for a GNSS occultation, and an interpolation for a ground observation.

In S502, the physical residual as a penalty term is incorporated into the loss function of the physical constraint L_{MO} as the soft constraints.

The soft constraints include: soft constraints for the Monin-Obukhov similarity theory and soft constraints for a wake.

The soft constraints for the Monin-Obukhov similarity theory include: joint residual penalties for a wind speed profile function, a stability function, and a consistency of a surface flux closure.

The soft constraints for the wake are constructed based on a parameterized wake model, and impose a lightweight penalty of amplitude and range on a low-frequency wind speed loss in a downwind direction of a unit.

In S503, the projection correction is performed on the preliminary 3D analysis field.

Specifically, a manifold projection technology is used to forcibly correct the preliminary 3D analysis field to a feasible domain that satisfies the physical constraints, achieving the projection correction.

In S6, multi-sample generation and statistical integration are performed on the physically compliant 3D analysis field in S5 to output a mean and a uncertainty of the physically compliant 3D analysis field, and providing products and quality indicators for key height layers of wind power.

Specifically, randomness of the generative model is used to perform multiple parallel samples on an input at a same moment and under same conditions, a statistical mean of all sampled samples is calculated as a final analysis value of a wind field, and a pixel-level variance is calculated as an uncertainty measure of a wind speed at the same moment.

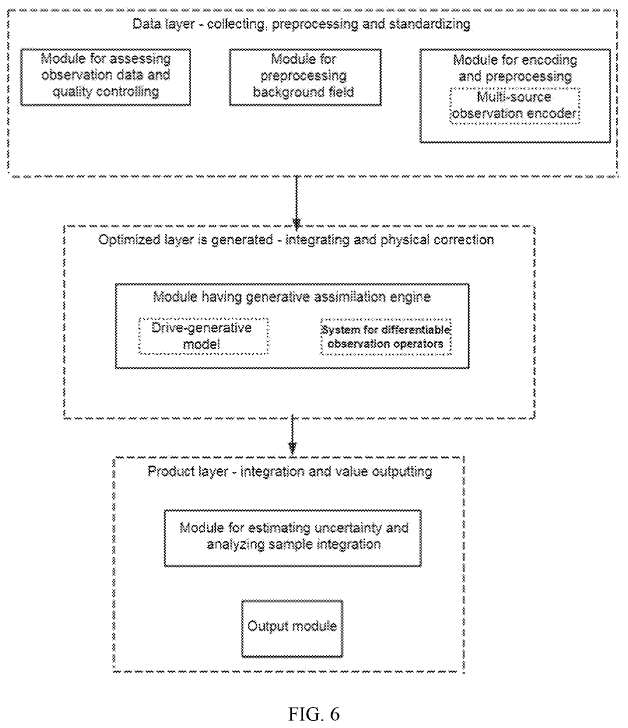

The overall functional architecture of the system of the present disclosure is shown in FIG. 6. Specifically, the overall functional architecture of the system includes: a module for assessing observation data and quality controlling, a module for preprocessing background field, a module for encoding and preprocessing, a module having generative assimilation engine, a module for estimating uncertainty and analyzing sample integration, and an output module. The module for assessing observation data and quality controlling is configured for collecting LIDAR, SCADA and other data. The module for preprocessing background field is configured for acquiring and preprocessing the background field. The module for encoding and preprocessing is configured for performing operator mapping and feature encoding. The module having generative assimilation engine has a drive-generative model and a system for differentiable observation operators. The module for estimating uncertainty and analyzing sample integration is configured for calculating a mean and a uncertainty.

The following three embodiments respectively illustrate the specific application scenarios of the four-dimensional assimilation method for wind farm data based on physical constraints and generative AI of the present disclosure in different geographical environments (nearshore, complex mountainous areas) and different business scales (station level, grid level). They share the same system architecture and core algorithm (S1-S6), but have adjusted observation operator combinations, physical constraint weights, and grid parameters for specific scenarios.

### Embodiment 1

An assimilation system applied to offshore wind farm clusters, includes following steps (1) to (4).
(1) Region and Grid Setting: The coverage area is the offshore wind power belt (approximately 200 kilometers×200 kilometers), with a horizontal resolution of 1 kilometer and 70 layers set vertically. 20 layers are densified within the range from the surface to a height of 300 meters. The assimilation window is set to 20 minutes and updates in a scrolling manner every 10 minutes.
(2) Data Source: Observational data includes profile data for buoy and offshore vertical LIDAR (10-250 meters, 1-10 minutes), power data for wind turbine nacelle anemometer and SCADA, offshore ground station observations, geostationary satellite microwave wind products, and GNSS reverse osmosis (RO) thermal background data. The background field data originates from the 3-6 hours' short-term and impending prediction of the regional NWP model or the downsampling field of the AI large model.
(3) Model and Hyperparameters: A conditional diffusion model is used with 12 sampling steps and 16 generated samples. The training process is shown in FIG. 2, with weight coefficients set to λ_{obs}=1.2, λ_{bak}=0.4, and λ_{phy}=0.7. In the physical loss sub item, the continuity constraint weight is 0.2, the MO/flux constraint weight is 0.4, the thermal constraint weight is 0.1, the geostrophic constraint weight is 0.2, and the wake constraint weight is 0.1.
(4) Expected Effect: At a hub height (100-120 meters), the analysis field wind speed is reduced by 20-35% compared to the observed O-A (observation minus analysis) standard deviation and O-B (observation minus background) standard deviation. The normalized mean absolute error (NMAE) of power prediction decreases by 8-15%, and the F1 score of power ramp event detection during storm passage increases by 5-10%.

### Embodiment 2

An assimilation system for complex terrain onshore wind farms, includes followings steps (1) to (5).
(1) Region and Grid Setting: The coverage area is the mountainous and hilly wind power corridor (approximately 150 kilometers×150 kilometers), with a horizontal resolution set at 0.5-1 kilometers and 80 layers vertically. 24 layers are densely arranged from the surface to a height of 300 meters. The assimilation window is set to 30 minutes and updates in a scrolling manner every 15 minutes.
(2) Data Source: Observational data includes data from multi-height wind-detecting towers (10/30/50/80/100/150 meters), cabin wind speed and yaw data, scanning LIDAR (Plan Position Indicator (PPI) mode, radius 10-15 kilometers), data for ground automatic station, and data for satellite brightness temperature.
(3) Operators and Constraints: The geometric operator of LIDAR radial velocity is strictly implemented using sight line vectors corrected by terrains. The MO physical constraints consider the influence of local surface roughness zo and terrain secondary parameters (slope, orientation).
(4) Model and Hyperparameters: A conditional diffusion model is used, with 12 sampling steps and 12 generated samples. In the total loss function, the weight coefficients are set as follows: λ_{obs}=1.3, λ_{bak}=0.5, λ_{phy}=0.8, where the MO/flux sub term accounts for 0.5 in the physical loss.
(5) Expected Effect: RMSE of wind speed at wheel-hub height decreases by 0.6-1.2 meters/second, RMSE of direction decreases by 5-10°. The normalized root mean square error (NRMSE) of power prediction decreased by 10-18%, effectively correcting the power overestimation bias in low-wind-speed areas (3-6 meters/second).

### Embodiment 3

An assimilation system for cross field group fusion and grid level prediction, includes following steps (1) to (4).
(1) Region and Grid Setting: The coverage area covers multiple wind farm clusters (500 kilometers×500 kilometers), with a horizontal resolution of 2 kilometers and 60 layers vertically. The assimilation window is set to 60 minutes and updated by scrolling every 30 minutes.
(2) Data Source: Observation data is a sampling summary of data of tower, cabin, and SCADA from multiple stations (using a privacy preserving and aggregating technology), supplemented by satellite, RO, Sounding and other data to provide a large-scale thermal background.
(3) Model Features: To ensure the balance of large-scale fields, the model emphasizes more on geostrophic consistency and large-scale balance, thus appropriately reducing the weight of soft constraints for the wake. The constraint weight for background field λ_{b} is set to 0.6, and the weight for physical constraints λ_{phys} is set to 0.6.
(4) Expected Effect: The continuous graded probability score (CRPS) for regional total power prediction will decrease by 8-12%. The hit rate of power ramp warning at the system level has increased, while the false alarm rate has decreased.

Finally, it should be noted that the above embodiments are only used to illustrate the technical solution of the present disclosure and not to limit it. Although the present disclosure has been described in detail with reference to the preferred embodiments, those skilled in the art should understand that modifications or equivalent substitutions can still be made to the technical solution of the present disclosure, and these modifications or equivalent substitutions cannot make the modified technical solution deviate from the spirit and scope of the technical solution of the present disclosure.

What is claimed is:

1. A four-dimensional assimilation method for wind farm data based on physical constraints and generative artificial intelligence (AI), comprising:
S1: collecting sparse, irregular, and asynchronous wind-detecting observation data from a wind farm and performing quality control to obtain wind-detecting observation data at a plurality of moments within an assimilation time window;
S2: obtaining a raw data of a short-term and impending prediction from a previous moment as a raw data of a background field, and performing multi-scale preprocessing and uncertainty encoding on the raw data of the background field;
S3: encoding the wind-detecting observation data at the plurality of moments in S1 into conditional features comprising spatial position, height, time, type, and quality identification through a multi-source observation encoder;
S4: using the raw data of the background field after the multi-scale preprocessing and the uncertainty encoding in S2 and the conditional features in S3 as joint conditional inputs to drive a generative model, and performing a reverse denoising sampling to generate a preliminary three-dimensional (3D) analysis field;
S5: during and/or after a generation of the preliminary 3D analysis field, applying soft constraints and a projection correction to the preliminary 3D analysis field generated in S4 based on the physical constraints composed of boundary layers and large-scale physical equations to obtain a physically compliant 3D analysis field; and
S6: performing multi-sample generation and statistical integration on the physically compliant 3D analysis field in S5 to output a mean and a uncertainty of the physically compliant 3D analysis field, and providing products and quality indicators for key height layers of wind power.

2. The four-dimensional assimilation method for wind farm data based on the physical constraints and generative AI according to claim 1, wherein the wind-detecting observation data in S1 comprises: tower anemometer data, cabin anemometer data, sonic detection and ranging (SODAR)/light detection and ranging (LIDAR) profile data and scanning data, supervisory control and data acquisition (SCADA) power data and wind speed data derived thereof, and/or traditional meteorological observation data.

3. The four-dimensional assimilation method for wind farm data based on the physical constraints and generative AI according to claim 2, wherein S4 comprises:
S401: constructing the joint conditional inputs;
S402: constructing an overall objective function of the generative model;
S403: constructing a loss function of the physical constraints; and
S404: driving the generative model for performing the reverse denoising sampling to generate the preliminary 3D analysis field.

4. The four-dimensional assimilation method for wind farm data based on the physical constraints and generative AI according to claim 3, wherein an expression of the overall objective function of the generative model constructed in S402 is as follows:
$${L}_{total} = {L}_{diff} + {λ}_{phy} {L}_{phy} + {λ}_{obs} {L}_{obs} + {λ}_{b a k} {L}_{b a k} ;$$
wherein Lₜₒₜₐₗ is a total training loss of the generative model; L_{diff} is a fundamental loss of a diffusion model; λ_{phy} is a weight coefficient of a physical loss; L_{phy} is a loss term of the physical constraints, which is a set term that comprises a sum of a molecular orbital (MO) theoretical residual, a quality continuity residual, and a plurality of physical sub terms; λ_{obs} is a weight coefficient of an observation loss; L_{obs} is a loss term of an observation fitting; λ_{bak} is a weight coefficient of a background field constraint, and L_{bak} is a loss term of the background field constraint.

5. The four-dimensional assimilation method for wind farm data based on the physical constraints and generative AI according to claim 4, wherein an expression of the loss function of the physical constraints constructed in S403 is as follows:
$${L}_{MO} = {‖ \frac{κ z}{u *} \frac{\partial U}{\partial z} - {ϕ}_{m} ( \frac{z}{L} ) ‖}^{2} ;$$
wherein L_{MO} is an Monin-Obukhov physical residual loss; κ is a von Karman constant; z is a vertical height; u* is a friction velocity; U is an average wind speed;
$$\frac{\partial U}{\partial z}$$
is a wind shear; φₘ is a momentum dimensionless wind shear function; L is an Monin-Obukhov length; ∥⋅∥² is an L2 norm and
$$\frac{z}{L}$$
is an atom sopheric stability parameter.

6. The four-dimensional assimilation method for wind farm data based on the physical constraints and generative AI according to claim 5, wherein S5 comprises:
S501: calculating a physical residual of the preliminary 3D analysis field;
S502: incorporating the physical residual as a penalty term into the loss function of the physical constraints L_{MO} as the soft constraints; and
S503: performing the projection correction on the preliminary 3D analysis field.

7. The four-dimensional assimilation method for wind farm data based on the physical constraints and generative AI according to claim 6, wherein the calculating the physical residual of the preliminary 3D analysis field in S501 comprises:
calculating continuity Navier-Stokes equations in fluid mechanics and thermodynamic equations of the preliminary 3D analysis field; and calculating the physical residual under an Monin-Obukhov similarity function using differentiable observation operators;
using the differentiable observation operators to map a generated 3D grid point wind field x back to an observation space to obtain a simulated observation value y_{pred}, wherein y_{pred} is expressed as:
$${y}_{pred} = H ( x ) ;$$
wherein H(⋅) represents a differentiable observation operator;
calculating an observation residual based on y_{pred}, expressed as:
$$‖ y - H ( x ) ‖ ;$$
wherein y represents an actual observation value, and ∥⋅∥ represents a norm; and
updating a wind field based on the observation residual;
wherein the differentiable observation operators comprise at least one of a geometry operator for radial velocity of a scanning LIDAR, an interpolation operator for a tower/cabin height and terrain consistency, a correction operator for a cabin wind speed yaw/pitch, a differentiable mapping operator for an SCADA power-wind speed-air density, a transfer operator for a satellite radiation, a refractive index operator for a global navigation satellite system (GNSS) occultation, and an interpolation for a ground observation.

8. The four-dimensional assimilation method for wind farm data based on the physical constraints and generative AI according to claim 7, wherein the soft constraints in S502 comprise: soft constraints for an Monin-Obukhov similarity theory and soft constraints for a wake;
wherein the soft constraints for the Monin-Obukhov similarity theory comprise: joint residual penalties for a wind speed profile function, a stability function, and a consistency of a surface flux closure; and
the soft constraints for the wake are constructed based on a parameterized wake model, and impose a lightweight penalty of amplitude and range on a low-frequency wind speed loss in a downwind direction of a unit.

9. The four-dimensional assimilation method for wind farm data based on the physical constraints and generative AI according to claim 8, wherein the performing the projection correction on the preliminary 3D analysis field in S503 comprises:
using a manifold projection technology to forcibly correct the preliminary 3D analysis field to a feasible domain that satisfies the physical constraints, achieving the projection correction.

10. The four-dimensional assimilation method for wind farm data based on the physical constraints and generative AI according to claim 9, wherein S6 comprises:
using randomness of the generative model to perform a plurality of parallel samples on an input at a same moment and under same conditions, calculating a statistical mean of all sampled samples as a final analysis value of a wind field, and calculating a pixel level variance as an uncertainty measure of a wind speed at the same moment.
